(19) United States
(12) Patent Application Publication
(10) Pub. No.: US 2015/0196030 A1
(43) Pub. Date: Jul. 16, 2015

(54) HERBICIDAL COMPOSITION CONTAINING 4-AMINO-3-CHLORO-6-(4-CHLORO-2-FLUORO-3-METHOXYPHENYL) PYRIDINE-2-CARBOXYLIC ACID OR DERIVATIVES THEREOF, FLUROXYPYR OR DERIVATIVES THEREOF, AND PHENOXY AUXINS OR DERIVATIVES THEREOF

(71) Applicant: DOW AGROSCIENCES LLC, Indianapolis, IN (US)

(72) Inventors: Rory Degenhardt, Edmonton (CA); Bill McGregor, Beaumont (CA)

(73) Assignee: DOW AGROSCIENCES LLC, Indianapolis, IN (US)

(21) Appl. No.: 14/596,260

(22) Filed: Jan. 14, 2015

Related U.S. Application Data
(60) Provisional application No. 61/927,829, filed on Jan. 15, 2014.

(51) Int. Cl. A01N 43/40; A01N 43/42; A01N 37/10

(52) U.S. Cl. CPC A01N 43/40; A01N 37/10; A01N 43/42

(57) ABSTRACT

Provided herein are herbicidal compositions comprising a mixture comprising (a) 4-amino-3-chloro-6-(4-chloro-2-fluoro-3-methoxyphenyl)pyridine-2-carboxylic acid or an agriculturally acceptable ester, amide, or salt thereof, (b) fluroxypyr or an agriculturally acceptable ester, amide, or salt thereof, and (c) MCPA or 2,4-D or agriculturally acceptable esters, amides, or salts thereof. The compositions provide synergistic weed control of undesirable vegetation in areas including, but not limited to, cereals, rice, range and pasture areas, industrial vegetation management (IVM), and rights-of-way.

### CROSS REFERENCE TO RELATED APPLICATIONS

This application claims the benefit of U.S. Provisional Patent Application Ser. No. 61/927,829 filed Jan. 15, 2014, which is expressly incorporated by reference herein.

### BACKGROUND

The protection of crops from weeds and other vegetation which inhibit crop growth is a recurring problem in agriculture. To help combat this problem, a variety of chemicals and chemical formulations effective in the control of such unwanted growth have been synthesized and evaluated. Different classes of chemical herbicides have been disclosed in the literature and a large number are in commercial use. However, there remains a need for improved compositions and methods of use thereof that are effective in controlling undesirable vegetation.

### SUMMARY

Compositions for controlling undesirable vegetation containing a mixture containing synergistic, herbicidally effective amounts of:

(a) a compound of the formula (I) or, with respect to its carboxylic acid moiety, an agriculturally acceptable salt, ester, or amide thereof

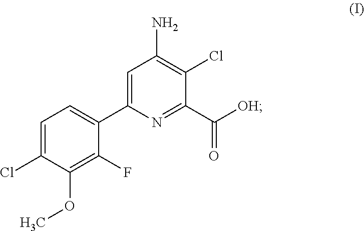 [SMILES: COc1c(Cl)ccc(-c2cc(N)c(Cl)c(C(=O)O)n2)c1F]

(b) fluroxypyr or, with respect to its carboxylic acid moiety, an agriculturally acceptable salt, ester, or amide thereof

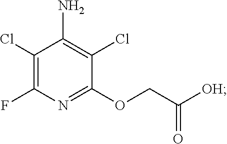 [SMILES: Nc1c(Cl)c(F)nc(OCC(=O)O)c1Cl]

and

(c) one or more phenoxy auxins or agriculturally acceptable salts, esters, and/or amides thereof.

Methods of controlling undesirable vegetation including contacting the undesirable vegetation, the area adjacent to the undesirable vegetation, water, or soil with a composition containing a mixture containing synergistic, herbicidally effective amounts of a compound of formula (I) or, with respect to its carboxylic acid moiety, an agriculturally acceptable salt, ester, or amide thereof; fluroxypyr or, with respect to its carboxylic acid moiety, an agriculturally acceptable salt, ester, or amide thereof; and one or more phenoxy auxins or, an agriculturally acceptable salt, ester, or amide thereof are described herein.

In some embodiments, (a) is the methyl ester or triethylammonium salt of the compound of formula (I). In some embodiments, (b) is the 1-methylheptyl ester of fluroxypyr. In some embodiments, the phenoxy auxin is MCPA and/or 2,4-D. In some embodiments, the phenoxy auxin is MCPA 2-ethylhexyl ester and/or 2,4-D choline. In one embodiment, the composition includes (a) the methyl ester of the compound of formula (I) or halauxifen-methyl, (b) the 1-methylheptyl ester of fluroxypyr or fluroxypyr-meptyl, and (c) MCPA 2-ethylhexyl ester. In one embodiment, the composition includes (a) the methyl ester of the compound of formula (I) or halauxifen-methyl, (b) the 1-methylheptyl ester of fluroxypyr or fluroxypyr-meptyl, and (c) 2,4-D 2-ethylhexyl ester.

Also described herein are kits for controlling undesirable vegetation including a first composition comprising a herbicidally effective amount of (a) a compound of the formula (I) or, with respect to its carboxylic acid moiety, an agriculturally acceptable salt, ester, or amide thereof, and (b) fluroxypyr or, with respect to its carboxylic acid moiety, an agriculturally acceptable salt, ester, or amide thereof; and a second composition comprising a herbicidally effective amount of (c) one or more phenoxy auxins or an agriculturally acceptable salt, ester, or amide thereof. In some embodiments, the first composition and the second composition are contained separately in the kit.

### DETAILED DESCRIPTION

### I. Definitions

As used herein, the compound of formula (I) is halauxifen or 4-amino-3-chloro-6-(4-chloro-2-fluoro-3-methoxyphenyl)-2-pyridineccarboxylate and has the following structure:

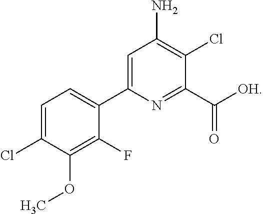 [SMILES: COc1c(Cl)ccc(-c2cc(N)c(Cl)c(C(=O)O)n2)c1F]

Exemplary chemical forms of halauxifen include, but are not limited to, for example, halauxifen-methyl, which is methyl 4-amino-3-chloro-6-(4-chloro-2-fluoro-3-methoxyphenyl)-2-pyridinecarboxylate and has the following structure:

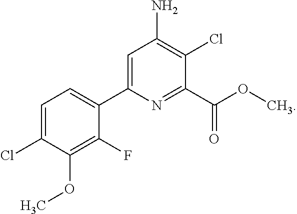 [SMILES: COC(=O)c1nc(-c2ccc(Cl)c(OC)c2F)cc(N)c1Cl]

Halauxifen is described in U.S. Pat. No. 7,314,849 B2, which is incorporated herein by reference in its entirety. Exemplary uses of halauxifen include, but are not limited to, controlling annual grass weeds including Setaria, Pennisetum and Echinochloa; broadleaf weeds such as Papaver spp., Erodium spp., Galium spp., Galeopsis spp., Lamium spp., Kochia spp., Malva spp., Amaranthus spp., Aeschynomene spp., Sesbania spp., Stellaria spp. and Monochoria spp.; and sedge species such as Cyperus spp. and Scirpus/Schoenoplectus spp. Halauxifen-methyl may be used as other forms, e.g., halauxifen K⁺ (potassium 4-amino-3-chloro-6-(4-chloro-2-fluoro-3-methoxyphenyl) picolinate), which has the following structure:

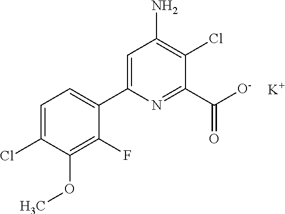 [SMILES: COc1c(Cl)ccc(-c2cc(N)c(Cl)c(C(=O)[O-])n2)c1F ; [K+]]

The compound of formula (I) can be in the form of an ester including, but not limited to, a C₁-C₄ alkyl, e.g., a methyl ester, or benzyl ester.

As used herein, fluroxypyr is 2-[(4-amino-3,5-dichloro-6-fluoro-2-pyridinyl)oxy]acetic acid and has the following structure:

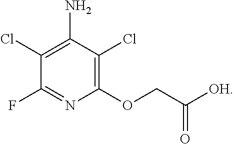 [SMILES: Nc1c(Cl)c(F)nc(OCC(=O)O)c1Cl]

Exemplary uses of fluroxypyr are described in Tomlin, C. D. S., Ed. The Pesticide Manual: A World Compendium, 15^{th} ed.; BCPC: Alton, 2009 (hereafter “The Pesticide Manual, Fifteenth Edition, 2009.”). Exemplary uses of fluroxypyr include, but are not limited to, post-emergence foliar application to control broadleaf weeds, e.g., in small grain crops, to control Rumex spp., Galium spp., Kochia spp., Stellaria spp. and Urtica dioica in pastures, and to control Trifolium repens in amenity grassland. Other exemplary uses include, but are not limited to, controlling herbaceous and woody broadleaf weeds, e.g., in orchards and plantation crops, and broadleaf brush, e.g., in conifer forests. Exemplary chemical forms of fluroxypyr include, but are not limited to, for example, fluroxypyr-meptyl or fluroxypyr MHE, which is 1-methylheptyl 2-[(4-amino-3,5-dichloro-6-fluoro-2-pyridinyl)oxy]acetate and has the following structure:

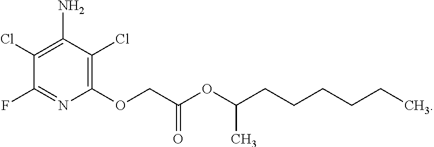 [SMILES: CCCCCCC(C)OC(=O)COc1nc(F)c(Cl)c(N)c1Cl]

As used herein, MCPA is 2-(4-chloro-2-methylphenoxy)acetic acid and has the following structure:

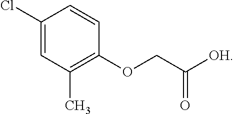

Exemplary uses of MCPA are described in The Pesticide Manual, Fifteenth Edition, 2009. Exemplary uses of MCPA include, but are not limited to, post-emergence control of annual and perennial broadleaf weeds, e.g., in cereals, herbage seed crops, flax, rice vines, peas, potatoes, asparagus, grassland, turf, under fruit trees, and roadside verges/shoulders and embankments. Other exemplary uses include, but are not limited to, controlling broadleaf and woody weeds, e.g., in forestry, as well as aquatic broadleaf weeds. Exemplary agriculturally acceptable salts or esters of MCPA include, but are not limited to, sodium salts, potassium salts, ammonium salts or substituted ammonium salts, in particular mono-, di- and tri-C₁-C₈-alkylammonium salts such as methyl ammonium, dimethylammonium and isopropylammonium (e.g., triisopropanolammonium), mono-, di- and tri-hydroxy-C₂-C₈-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts, diglycolamine salts, and esters, in particular its C₁-C₈-alkyl esters and C₁-C₄-alkoxy-C₂-C₄-alkyl esters, such as methyl esters, ethyl esters, isopropyl, butyl, hexyl, heptyl, isoheptyl, isooctyl, 2-ethylhexyl and butoxyethyl esters. Exemplary agriculturally acceptable esters and salts of MCPA include, but are not limited to, the ethyl, isopropyl, butyl, isobutyl, isooctyl, 2-ethylhexyl, and 2-butoxyethyl esters of MCPA, and the sodium, isopropyl-ammonium, dimethylammonium, diethanolammonium, diisopropylammonium, triethanol-ammonium, triisopropylammonium, triisopropanolammonium, and choline salts of MCPA, and mixtures thereof. In one preferred embodiment, the MCPA is in the form of a 2-ethylhexyl ester (MCPA EHE), which is 2-ethylhexyl 2-(4-chloro-2-methylphenoxy)acetate and has the following structure:

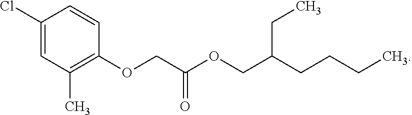 [SMILES: CCCCC(CC)COC(=O)COc1ccc(Cl)cc1C]

As used herein, 2,4-D is 2,4-dichlorophenoxyacetic acid, which has the following structure:

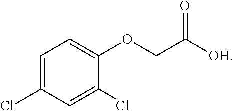 [SMILES: O=C(O)COc1ccc(Cl)cc1Cl]

Exemplary uses of 2,4-D are described in The Pesticide Manual, Fifteenth Edition, 2009. Exemplary uses of 2,4-D include, but are not limited to, post-emergence control of annual and perennial broadleaf weeds, e.g., in cereals, maize, sorghum, grassland, fallowland, pasture, rangeland, established turf, grass seed crops, orchards, cranberries, asparagus, sugarcane, rice, forestry, soybeans (preplant), and non-crop land. 2,4-D can be provided in its acid form, or as an agriculturally acceptable salt or ester thereof. Exemplary agriculturally acceptable salts or esters of 2,4-D include, but are not limited to, sodium salts, potassium salts, ammonium salts or substituted ammonium salts, in particular mono-, di- and tri-C₁-C₈-alkylammonium salts such as methyl ammonium, dimethylammonium and isopropylammonium (e.g., triisopropanolammonium), mono-, di- and tri-hydroxy-C₂-C₈-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts, diglycolamine salts and esters, in particular its C₁-C₈-alkyl esters and C₁-C₄-alkoxy-C₂-C₄-alkyl esters, such as methyl esters, ethyl esters, isopropyl, butyl, hexyl, heptyl, isoheptyl, isooctyl, 2-ethylhexyl and butoxyethyl esters. Exemplary agriculturally acceptable esters or salts of 2,4-D can include, but are not limited to, the ethyl, isopropyl, butyl, isobutyl, isooctyl, 2-ethylhexyl, and 2-butoxyethyl esters of 2,4-D, and the sodium, isopropylammonium, dimethylammonium, diethanolammonium, diisopropylammonium, triethanolammonium, triisopropylammonium, triisopropanolammonium, and choline salts of 2,4-D, and mixtures thereof. In some embodiments, the 2,4-D is provided as an amine salt, such as 2,4-D-olamine salt, dimethylamine (DMA) salt, monoethanolamine (MEA) salt, triisopropanolamine (TIPA) salt, or a mixture thereof. In one preferred embodiment, the 2,4-D is in the form of a 2-ethylhexyl ester (2,4-D EHE), which is 2-ethylhexyl(2,4-dichlorophenoxy)acetate and has the following structure:

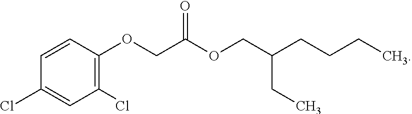 [SMILES: CCCCC(CC)COC(=O)COc1ccc(Cl)cc1Cl]

The term herbicide is used herein to mean an active ingredient that kills, controls or otherwise adversely modifies the growth of plants. As used herein, a herbicidally effective or vegetation controlling amount is an amount of active ingredient that causes a “herbicidal effect”, i.e. an adversely modifying effect and includes deviations from natural development, killing, regulation, desiccation, and retardation.

As used herein, the terms “plants” and “vegetation” include, but are not limited to, germinant seeds, emerging seedlings, plants emerging from vegetative propagules, and established vegetation.

As used herein, immature vegetation refers to small vegetative plants prior to reproductive stage, and mature vegetation refers to vegetative plants during and after the reproductive stage.

### II. Compositions

A. Synergistic Mixtures

Provided herein are herbicidal compositions containing a mixture containing synergistic, herbicidally effective amounts of:

(a) a compound of formula (I) or, with respect to the carboxylic acid moiety, an agriculturally acceptable salt, ester or amide thereof

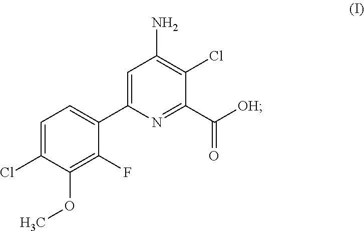 [SMILES: COc1c(Cl)ccc(-c2cc(N)c(Cl)c(C(=O)O)n2)c1F]

(b) fluroxypyr, or with respect to its carboxylic acid moiety, an agriculturally acceptable salt, ester, or amide thereof

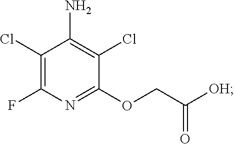 [SMILES: Nc1c(Cl)c(F)nc(OCC(=O)O)c1Cl]

and
(c) one or more phenoxy auxins or an agriculturally acceptable salt, ester, or amide thereof.

In some embodiments, (a) is the methyl ester or triethylammonium salt of the compound of formula (I). In some embodiments, (b) is the 1-methylheptyl ester of fluroxypyr or fluroxypyr-meptyl. In some embodiments, the phenoxy auxin is MCPA and/or 2,4-D. In some embodiments, the phenoxy auxin is MCPA 2-ethylhexyl ester and/or 2,4-D choline. In other embodiments, (a) is the methyl ester of the compound of formula (I) or halauxifen-methyl, (b) is the 1-methylheptyl ester of fluroxypyr or fluroxypyr-meptyl, and (c) is MCPA 2-ethylhexyl ester. In other embodiments, (a) is the methyl ester of the compound of formula (I) or halauxifen-methyl, (b) is the 1-methylheptyl ester of fluroxypyr or fluroxypyr-meptyl, and (c) 2,4-D 2-ethylhexyl ester.

Furthermore, in some embodiments, the combination of a compound of formula (I) or, with respect to the carboxylic acid moiety, an agriculturally acceptable salt, ester or amide thereof; fluroxypyr, or with respect to its carboxylic acid moiety, an agriculturally acceptable salt, ester, or amide thereof; and one or more phenoxy auxins or an agriculturally acceptable salt, ester, or amide thereof exhibit synergism, i.e., the herbicidal active ingredients are more effective in combination than when applied individually. Synergism has been defined as “an interaction of two or more factors such that the effect when combined is greater than the predicted effect based on the response of each factor applied separately.” Shaner, D. L., Ed. Herbicide Handbook, 10^{th} ed. Lawrence: Weed Science Society of America, 2014. In certain embodiments, the compositions exhibit synergy as determined by Colby's equation. Colby, S. R. Calculation of the synergistic and antagonistic response of herbicide combinations. Weeds 1967, 15, 20-22.

Herbicidal activity is exhibited by the compounds when they are applied pre- and post-emergence directly to the plant or to the locus of the plant at any stage of growth. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, the amount of chemical applied, and combinations thereof. These and other factors can be adjusted to promote non-selective or selective herbicidal action. In some embodiments, the compositions described herein are applied as a post-emergence or pre-emergence application to crops and weeds grown in soil, or in-water application to flooded paddy rice or water bodies (e.g., ponds, lakes and streams), to relatively immature to mature undesirable vegetation to achieve the maximum control of weeds. In some embodiments, the compositions and methods are applied prior to planting the crop. In certain embodiments, the compositions and methods are applied via burn-down.

In some embodiments, the compositions or components of the compositions described herein are applied as a post-emergence foliar application to immature, undesirable vegetation to achieve the maximum control of weeds.

In some embodiments, the compositions and methods provided herein are utilized to control weeds in crops, e.g., to cereals, rice, perennial plantation crops, corn, sorghum, oilseed rape, turf, range and pasture, industrial vegetation management (IVM), rights-of-way and in any auxinic-tolerant crops. In some embodiments, the compositions and methods are utilized to control weeds in cereals or oilseed rape.

The present compositions can be applied to weeds or their locus thereof, including but not limited to foliage, soil or water, by the use of conventional ground or aerial dusters, sprayers, and granule applicators, by addition to irrigation or paddy water, and by other conventional means known to those skilled in the art.

In one embodiment, the concentration of the active ingredients in the synergistic composition of the present disclosure is from 0.001 to 98 percent by weight, and in another embodiment, concentrations from 0.01 to 90 percent by weight are employed. In compositions designed to be employed as concentrates, the active ingredients are present in a concentration from 2 to 98 weight percent, and in another embodiment, from 5 to 90 weight percent. In one embodiment, such compositions are diluted with an inert carrier, such as water, before application. The diluted compositions described herein that are applied to weeds or the loci of weeds contain 0.005 to 5 weight percent active ingredient (ai) and, in another embodiment contain 0.01 to 2.0 weight percent ai.

In certain embodiments of the compositions and methods described herein, the compound of formula (I) or an ester, amide, or salt thereof is used in combination with fluroxypyr or an ester, amide, or salt thereof, and MCPA and/or 2,4-D or esters, amides, or salts thereof. In some embodiments, the carboxylic acid equivalent weight ratio of the compound of formula (I) or an ester, amide, or salt thereof to fluroxypyr or an ester, amide, or salt thereof to MCPA or 2,4-D or esters, amides, or salts thereof is from about 1:10:50 to about 1:30:120 (i.e., 1:(10-30):(50-120)). In some embodiments, the carboxylic acid equivalent weight ratio is from about 1:12:50 to about 1:18:90 (i.e., 1:(12-18):(50-90)). In some embodiments, the carboxylic acid equivalent weight ratio is from about 1:14:50 to about 1:16:90 (i.e., 1:(14-16):(50-90)). In some embodiments, the carboxylic acid equivalent weight ratio is about 1:15:50 to about 1:15:90 (i.e., 1:15:(50-90)). In some embodiments, the carboxylic acid equivalent weight ratio is from about 1:10:55 to about 1:20:85 (i.e., 1:(10-20):(55-85)). In some embodiments, the carboxylic acid equivalent weight ratio is from about 1:12:55 to about 1:18:85 (i.e., 1:(12-18):(55-85)). In some embodiments, the carboxylic acid equivalent weight ratio is from about 1:14:55 to about 1:16:85 (i.e., 1:(14-16):(55-85)). In some embodiments, the carboxylic acid equivalent weight ratio is from about 1:15:55 to about 1:15:85 (i.e., 1:15:(55-85)). In some embodiments, the carboxylic acid equivalent weight ratio is from about 1:10:60 to about 1:20:80 (i.e., 1:(10-20):(60-80)). In some embodiments, the carboxylic acid equivalent weight ratio is from about 1:12:60 to about 1:18:80 (i.e., 1:(12-18):(60-80)). In some embodiments, the carboxylic acid equivalent weight ratio is from about 1:14:60 to about 1:16:80 (i.e., 1:(14-16):(60-80)). In some embodiments, the carboxylic acid equivalent weight ratio is about 1:15:60 to about 1:15:80 (i.e., 1:15:(60-80)). In some embodiments, the carboxylic acid equivalent weight ratio is from about 1:10:65 to about 1:20:75 (i.e., 1:(10-20):(65-75)). In some embodiments, the carboxylic acid equivalent weight ratio is from about 1:12:65 to about 1:18:75 (i.e., 1:(12-18):(65-75)). In some embodiments, the carboxylic acid equivalent weight ratio is from about 1:14:65 to about 1:16:75 (i.e., 1:(14-16):(65-75)). In some embodiments, the carboxylic acid equivalent weight ratio is from about 1:15:65 to about 1:15:75 (i.e., 1:15:(65-75)). In some embodiments, the carboxylic acid equivalent weight ratio is from about 1:10:70 to about 1:20:70 (i.e., 1:(10-20):70). In some embodiments, the carboxylic acid equivalent weight ratio is from about 1:12:70 to about 1:18:70 (i.e., 1:(12-18):70). In some embodiments, the carboxylic acid equivalent weight ratio is from about 1:14:70 to about 1:16:70 (i.e., 1:(14-16):70). In some embodiments, the carboxylic acid equivalent weight ratio is about 1:15:70.

The rates at which the components of the compositions and methods are applied will depend upon the particular type of weed to be controlled, the degree of control required, and the timing and method of application. In one embodiment, the composition described herein can be applied at an application rate of from about 25 grams acid equivalent per hectare (g ae/ha) to about 610 g ae/ha based on the total amount of active ingredients in the composition, and in another embodiment from about 52 g ae/ha to about 235 g ae/ha. In some embodiments, the fluroxypyr or salt, ester, or amide is applied at a rate from about 25 g ae/ha to about 560 g ae/ha and the compound of formula (I) is applied at a rate from about 0.5 g ae/ha to about 50 g ae/ha. In another embodiment, the fluroxypyr, or salt, ester, of amide thereof is applied at a rate from about 50 g ae/ha to about 200 g ae/ha, and the compound of formula (I) is applied at a rate from about 2 g ae/ha to about 35 g ae/ha. In some embodiments, the compound of formula (I) is applied at a rate of less than 10 g ae/ha.

In some embodiments, the compound of formula (I) or ester, amide, or salt thereof is applied at a rate from about 1 g ae/ha to about 70 g ae/ha; the fluroxypyr or an ester, amide, or salt thereof is applied at a rate of about 2.5 g ae/ha to about 400 g ae/ha; and one or more phenoxy auxins or agriculturally acceptable ester, amide, or salt thereof is applied at a rate from about 200 g ae/ha to about 560 g ae/ha. In another embodiment, the compound of formula (I) or an ester, amide, or salt thereof is applied at a rate from about 2 g ae/ha to about 35 g ae/ha; the fluroxypyr or an ester, amide, or salt thereof is applied at a rate of about 5 g ae/ha to about 200 g ae/ha; and one or more phenoxy auxins or agriculturally acceptable ester, amide, or salt thereof is applied at a rate from about 280 g ae/ha to about 450 g ae/ha. In another embodiment, the compound of formula (I) or an ester, amide, or salt thereof is applied at a rate from about 2 g ae/ha to about 35 g ae/ha; the fluroxypyr or an ester, amide, or salt thereof is applied at a rate of about 5 g ae/ha to about 200 g ae/ha; and one or more phenoxy auxins or agriculturally acceptable ester, amide, or salt thereof is applied at a rate from about 350 g ae/ha to about 420 g ae/ha.

In certain embodiments, the compositions and methods utilize the methyl ester of the compound of formula (I); the meptyl ester of fluroxypyr; and the 2-ethylhexyl ester of MCPA. In one embodiment, the methyl ester of the compound of formula (I) is applied at a rate from about 2 g ae/ha to about 35 g ae/ha; the meptyl ester of fluroxypyr is applied at a rate of about 5 g ae/ha to about 150 g ae/ha; and the 2-ethylhexyl ester of MCPA is applied at a rate of about 350 g ae/ha to about 420 g ae/ha. In another embodiment, the methyl ester of the compound of formula (I) is applied at a rate of about 5 g ae/ha; the meptyl ester of fluroxypyr is applied at a rate of about 77 g ae/ha; and the MCPA 2-ethylhexyl ester is applied at a rate of about 350 g ae/ha.

In certain embodiments, the compositions and methods utilize the methyl ester of the compound of formula (I); the meptyl ester of fluroxypyr; and the 2-ethylhexyl ester of 2,4-D. In one embodiment, the methyl ester of the compound of formula (I) is applied at a rate from about 2 g ae/ha to about 35 g ae/ha; the meptyl ester of fluroxypyr is applied at a rate of about 5 g ae/ha to about 150 g ae/ha; and the 2-ethylhexyl ester of 2,4-D is applied at a rate of about 350 g ae/ha to about 420 g ae/ha. In another embodiment, the methyl ester of the compound of formula (I) is applied at a rate of about 5 g ae/ha; the meptyl ester of fluroxypyr is applied at a rate of about 77 g ae/ha; and the 2,4-D 2-ethylhexyl ester is applied at a rate of about 350 g ae/ha.

The components of the mixtures described herein can be applied either separately, sequentially, tankmixed or as part of a mixture or multipart herbicidal system. In some embodiments, both components may be formulated together (e.g., in the same formulation) or separately (e.g., in separate formulations) and applied simultaneously. In another embodiment, one or more components may be formulated separately and the components applied sequentially. In some embodiments of the methods described herein, the compound of formula (I) or derivative thereof, fluroxypyr or derivative thereof, and MCPA or 2,4-D or derivatives thereof are applied simultaneously, e.g., in the form of an intact composition. In some embodiments, the components are applied sequentially, e.g., within 5, 10, 15, or 30 minutes of each other; 1, 2, 3, 4, 5, 10, 12, 24, or 48 hour(s) or each other, or 1 week of each other.

In one embodiment, the compositions exhibit synergy against a variety of weed types. In one embodiment, the combination of the compound of formula (I) or an ester, amide, or salt thereof, fluroxypyr or an ester, amide, or salt thereof, and MCPA or 2,4-D or esters, amides, or salts thereof in a ratio of about 1:10:50 to about 1:25:100 exhibits greater than about 5, 6, 7, 8, 9, 10, 12, 15, 18, 20, 22, 25, 28, 30, 35, 40, 45, 50, 55, or 60% control compared to the Colby predicted value at 14-63 days after application (DAA).

In another embodiment, the compositions exhibit synergy as defined by the efficacy values defined above against a variety of weed types or crops, including but not limited to, Ambrosia artemisiifolia L. (common ragweed, AMBEL), Ambrosia trifida (giant ragweed, AMBTR), Artemisia absinthium (absinth wormwood, ARTAB), Brassica napus (volunteer canola, BRSNN), Galeopsis tetrahit (hemp-nettle, GAETE), Polygonum convolvulus (wild buckwheat, POLCO), Polygonum persicaria (lady's-thumb, POLPE), Trifolium pretense (red clover, TRFPR), Stellaria media (common chickweed, STEME).

B. Other Actives

The mixtures described herein can be applied in conjunction with one or more other herbicides to control a wider variety of undesirable vegetation. When used in conjunction with other herbicides, the composition can be formulated with the other herbicide or herbicides, tank-mixed with the other herbicide or herbicides or applied sequentially with the other herbicide or herbicides. Some of the herbicides that can be employed in conjunction with the compositions and methods described herein include, but are not limited to, acid, salt, and ester forms of the following herbicides: 4-CPA, 4-CPB, 4-CPP, 3,4-DA, 2,4-DB, 3,4-DB, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, bentazon, benthiocarb, benzadox, benzfendizone, benzipram, benzobicyclon, benzofenap, benzofluor, benzoylprop, benzthiazuron, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone (e.g., carfentrazone-ethyl), CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon (e.g., cinidon-ethyl), cinmethylin, cinosulfuron, cisanilide, clacyfos, clethodim, cliodinate, clodinafop-propargyl, clofop, clomazone, clomeprop, cloprop, cloproxydim, clopyralid, cloransulam, cloransulam-methyl, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop (e.g., cyhalofop-butyl), cyperquat, cyprazine, cyprazole, cypromid, daimuron, dalapon, dazomet, delachlor, desmedipham, desmetryn, di-allate, dicamba, dichlobenil, dichloralurea, dichloimate, dichlorprop, dichlorprop-P, diclofop-methyl, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethbenzamide, ethalfluralin, ethametsulfuron, ethidimuron, ethiolate, ethobenzanid, ethofumesate, ethoxyfen, ethoxysulfuron, etinofen, etnipromid, etobenzanid, EXD, fenasulam, fenoprop, fenoxaprop, fenoxaprop-P (e.g., fenoxaprop-P-ethyl), fenoxaprop-P-ethyl+isoxadifen-ethyl, fenoxasulfone, fenquinotrione, fenteracol, fenthiaprop, fentrazamide, fenuron, ferrous sulfate, flamprop, flamprop-M, flazasulfuron, florasulam, fluazifop, fluazifop-P (e.g., fluazifop-P-butyl), fluazolate, flucarbazone, flucetosulfuron, fluchloralin, flufenacet, flufenican, flufenpyr (e.g., flufenpyr-ethyl), flumetsulam, flumezin, flumiclorac (e.g., flumiclorac-pentyl), flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, fluroxypyr, flurtamone, fluthiacet, fomesafen, foramsulfuron, fosamine, fumiclorac, furyloxyfen, glufosinate-ammonium, glufosinate, halauxifen, halosafen, halosulfuron (e.g., halosulfuron-methyl), haloxydine, haloxyfop-methyl, haloxyfop-P (e.g., haloxyfop-P-methyl), hexachloroacetone, hexaflurate, hexazinone, imazamox, imazapic, imazapyr, imazaquin, imazethapyr, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA esters and amines, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, napropamide-M, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, parafluron, paraquat, pebulate, pelargonic acid, pendimethalin, penoxsulam, pentachlorophenol, pentanochlor, pentoxazone, perfluidone, pethoxamid, phenisopham, phenmedipham (e.g., phenmedipham-ethyl), phenobenzuron, phenylmercury acetate, picloram, picolinafen, pinoxaden, piperophos, potassium arsenite, potassium azide, potassium cyanate, pretilachlor, primisulfuron (e.g., primisulfuron-methyl), procyazine, prodiamine, profluazol, profluralin, profoxydim, proglinazine, prohexadione-calcium, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen (e.g., pyraflufen-ethyl), pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-sodium, pyroxasulfone, pyroxsulam, quinclorac, quinmerac, quinoclamine, quinonamid, quizalofop, quizalofop-P (e.g., quizalofop-P-ethyl), rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfuron-methyl, thiobencarb, tiafenacil, tiocarbazil, tioclorim, tolpyralate, topramezone, tralkoxydim, triafamone, tri-allate, triasulfuron, triaziflam, tribenuron (e.g., tribenuron-methyl), tricamba, triclopyr (e.g., triclopyr choline salt), tridiphane, trietazine, trifloxysulfuron, trifludimoxazin, trifluralin, triflusulfuron, trifop, trifopsime, trihydroxytriazine, trimeturon, tripropindan, tritac, tritosulfuron, vernolate, xylachlor, benzyl 4-amino-3-chloro-5-fluoro-6-(4-chloro-2-fluoro-3-methoxyphenyl)pyridine-2-carboxylate and salts, choline salts, esters, optically active isomers and mixtures thereof.

C. Safeners

In some embodiments, the compositions described herein are employed in combination with one or more herbicide safeners, such as AD-67 (MON 4660), benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, harpin proteins, isoxadifen-ethyl, jiecaowan, jiecaoxi, mefenpyr-diethyl, mephenate, naphthalic anhydride (NA), oxabetrinil, R29148 and N-phenylsulfonylbenzoic acid amides, to enhance their selectivity. In one embodiment, cloquintocet (e.g., acid or mexyl form) is used as a safener for the compositions described herein.

D. Adjuvants/Carriers

In some embodiments, the compositions provided herein further comprise at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water-dispersible granules, microcapsules or wettable powders, or liquids, such as, for example, emulsifiable concentrates, solutions, emulsions or suspensions. They can also be provided as a pre-mix or can be tank mixed or applied sequentially.

Suitable agricultural adjuvants and carriers include, but are not limited to, crop oil concentrate; nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99.

Liquid carriers that can be employed include water and organic solvents. The organic solvents used include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. In some embodiments, water is the carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, and the like.

In some embodiments, the compositions described herein further comprise one or more surface-active agents. In some embodiments, such surface-active agents are employed in both solid and liquid compositions, and in certain embodiments those designed to be diluted with carrier before application. The surface-active agents can be anionic, cationic or nonionic in character and can be employed as emulsifying agents, wetting agents, suspending agents, or for other purposes. Surfactants which may also be used in the present formulations are described, inter alia, in McCutcheon's Detergents and Emulsifiers Annual, MC Publishing Corporation: Ridgewood, N.J., 1998 and in Encyclopedia of Surfactants, Vol. I-III, Chemical Publishing Company: New York, 1980-81. Surface-active agents include, but are not limited to salts of alkyl sulfates, such as diethanolammonium lauryl sulfate; alkylarylsulfonate salts, such as calcium dodecyl benzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkyl-naphthalenesulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

In some embodiments, these materials, such as vegetable or seed oils and their esters, can be used interchangeably as an agricultural adjuvant, as a liquid carrier or as a surface active agent.

Other exemplary additives for use in the compositions provided herein include, but are not limited to compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

### III. Methods of Use

Methods of controlling undesirable vegetation comprising contacting the undesirable vegetation or locus thereof, including but not limited to foliage, soil or water, with a composition containing a mixture containing synergistic herbicidally effective amounts of (a) a compound of formula (I) or, with respect to its carboxylic acid moiety, an agriculturally acceptable salt, ester, or amide thereof; (b) fluroxypyr, or, with respect to its carboxylic acid moiety, an agriculturally acceptable salt, ester, or amide thereof; and (c) one or more phenoxy auxins or an agriculturally acceptable salt, ester, or amide thereof.

Additionally provided herein are kits for controlling undesirable vegetation comprising a first composition comprising a herbicidally effective amount of (a) a compound of formula (I) or, with respect to its carboxylic acid moiety, an agriculturally acceptable salt, ester, or amide thereof, and (b) fluroxypyr, or, with respect to its carboxylic acid moiety, an agriculturally acceptable salt, ester, or amide thereof; and a second composition comprising a herbicidally effective amount of (c) one or more phenoxy auxins or an agriculturally acceptable salt, ester, or amide thereof. In some embodiments, the phenoxy auxin is MCPA and/or 2,4-D. In other embodiments, the phenoxy auxin is MCPA 2-ethylhexyl ester and/or 2,4-D choline. In other embodiments, the phenoxy auxin is 2,4-D 2-ethylhexyl ester. In the kits, the first composition and the second composition are contained separately from each other. A non-limiting example of such a kit includes a first container including a premix formulation of the compound of formula (I) or, with respect to its carboxylic acid moiety, an agriculturally acceptable salt, ester, or amide thereof, and (b) fluroxypyr, or, with respect to its carboxylic acid moiety, an agriculturally acceptable salt, ester, or amide thereof; and a second container including (c) one or more phenoxy auxins or an agriculturally acceptable salt, ester, or amide thereof. In some embodiments, the phenoxy auxin is MCPA and/or 2,4-D. In some embodiments, the phenoxy auxin is MCPA 2-ethylhexyl ester and/or 2,4-D choline. In some embodiments, the phenoxy auxin is 2,4-D 2-ethylhexyl ester. The contents of the first and second containers can be combined, e.g., tank-mixed, prior to application. After mixing the first composition of the kits with the second composition, the combined composition will be the same as the compositions described herein and the combined composition can also be used in any of the methods described herein. In some embodiments, the methods provided herein are utilized to control undesirable vegetation in cereals. In certain embodiments, the undesirable vegetation is Alopecurus myosuroides Huds. (blackgrass, ALOMY), Apera spica-venti (L.) Beauv. (windgrass, APESV), Avena fatua L. (wild oat, AVEFA), Bromus tectorum L. (downy brome, BROTE), Lolium multiflorum Lam. (Italian ryegrass, LOLMU), Phalaris minor Retz. (littleseed canarygrass, PHAMI), Poa annua L. (annual bluegrass, POANN), Setaria pumila (Poir.) Roemer & J. A. Schultes (yellow foxtail, SETLU), Setaria viridis (L.) Beauv. (green foxtail, SETVI), Cirsium arvense (L.) Scop. (Canada thistle, CIRAR), Galium aparine L. (catchweed bedstraw, GALAP), Kochia scoparia (L.) Schrad. (kochia, KCHSC), Lamium purpureum L. (purple deadnettle, LAMPU), Matricaria recutita L. (wild chamomile, MATCH), Matricaria matricarioides (Less.) Porter (pineappleweed, MATMT), Papaver rhoeas L. (common poppy, PAPRH), Polygonum convolvulus L. (wild buckwheat, POLCO), Salsola tragus L. (Russian thistle, SASKR), Stellaria media (L.) Vill. (common chickweed, STEME), Veronica persica Poir. (Persian speedwell, VERPE), Viola arvensis Murr. (field violet, VIOAR), or Viola tricolor L. (wild violet, VIOTR). In other embodiments, the undesirable vegetation is Conyza canadensis (Canada fleabane, ERICA), Stellaria media (chickweed, STEME), Galium aparine (cleavers, GALAP), Galeopsis tetrahit (hemp-nettle GAETE), Chenopodium album (common lambsquarters, CHEAL), Kochia scoparia, (kochia, KCHSC), Ambrosia artemisiifolia L. (common ragweed, AMBEL), Amaranthus retroflexus (redroot pigweed, AMARE), Malva pusilla (roundleaf mallow, MALPU), Erodium cicutarium (stork's-bill, EROCI), Polygonum convolvulus (wild buckwheat, POLCO), Polygonum persicaria L. (ladysthumb, POLPE), Artemisia absinthium (absinth wormwood, ARTAB), Brassica napus (volunteer canola, BRSNN), Trifolium pretense (red clover, TRFPR), Ambrosia trifida L. (giant ragweed, AMBTR), or Medicago sativa (volunteer alfalfa, MEDSA).

In some embodiments, the composition and methods provided herein are utilized to control undesirable vegetation in range and pasture, IVM and rights-of-way. In certain embodiments, the undesirable vegetation is Ambrosia artemisiifolia L. (common ragweed, AMBEL), Cassia obtusifolia (sickle pod, CASOB), Centaurea maculosa auct. non Lam. (spotted knapweed, CENMA), Cirsium arvense (L.) Scop. (Canada thistle, CIRAR), Convolvulus arvensis L. (field bindweed, CONAR), Euphorbia esula L. (leafy spurge, EPHES), Lactuca serriola L./Torn. (prickly lettuce, LACSE), Melochia parviflora (escoba blanca, MEOPA), Plantago lanceolata L. (buckhorn plantain, PLALA), Rumex obtusifolius L. (broadleaf dock, RUMOB), Sida spinosa L. (prickly sida, SIDSP), Sinapis arvensis L. (wild mustard, SINAR), Sonchus arvensis L. (perennial sowthistle, SONAR), Solidago species (goldenrod, SOOSS), Taraxacum officinale G.H. Weber ex Wiggers (dandelion, TAROF), Trifolium repens L. (white clover, TRFRE), or Urtica dioica L. (common nettle, URTDI).

In some embodiments, the compositions and methods provided herein are utilized to control undesirable vegetation in rice. In certain embodiments, the undesirable vegetation is Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) LINK (junglerice, ECHCO), Echinochloa oryzoides (Ard.) Fritsch (early watergrass, ECHOR), Echinochloa oryzicola (Vasinger) Vasinger (late watergrass, ECHPH), Echinochloa spp, Ischaemum rugosum Salisb. (saramollagrass, ISCRU), Leptochloa chinensis (L.) Nees (Chinese sprangletop, LEFCH), Leptochloa fascicularis (Lam.) Gray (bearded sprangletop, LEFFA), Leptochloa panicoides (Presl.) Hitchc. (Amazon sprangletop, LEFPA), Panicum dichotomiflorum (L.) Michx. (fall panicum, PANDI), Paspalum dilatatum Poir. (dallisgrass, PASDI), Cyperus difformis L. (smallflower flatsedge, CYPDI), Cyperus esculentus L. (yellow nutsedge, CYPES), Cyperus iria L. (rice flatsedge, CYPIR), Cyperus rotundus L. (purple nutsedge, CYPRO), Eleocharis species (ELOSS), Fimbristylis miliacea (L.) Vahl (globe fringerush, FIMMI), Schoenoplectus juncoides Roxb. (Japanese bulrush, SCPJU), Schoenoplectus maritimus L. (sea clubrush, SCPMA), Schoenoplectus mucronatus L. (ricefield bulrush, SCPMU), Aeschynomene species, (jointvetch, AESSS), Alternanthera philoxeroides (Mart.) Griseb. (alligatorweed, ALRPH), Alisma plantago-aquatica L. (common waterplantain, ALSPA), Amaranthus species, (pigweeds and amaranths, AMASS), Ammannia coccinea Rottb. (redstem, AMMCO), Eclipta alba (L.) Hassk. (American false daisy, ECLAL), Heteranthera limosa (SW.) Willd./Vahl (ducksalad, HETLI), Heteranthera reniformis R. & P. (roundleaf mudplantain, HETRE), Ipomoea hederacea (L.) Jacq. (ivyleaf morningglory, IPOHE), Lindernia dubia (L.) Pennell (low false pimpernel, LIDDU), Monochoria korsakowii Regel & Maack (monochoria, MOOKA), Monochoria vaginalis (Burm. F.) C. Presl ex Kuhth, (monochoria, MOOVA), Murdannia nudiflora (L.) Brenan (doveweed, MUDNU), Polygonum pensylvanicum L., (Pennsylvania smartweed, POLPY), Polygonum persicaria L. (ladysthumb, POLPE), Polygonum hydropiperoides Michx. (mild smartweed, POLHP), Rotala indica (Willd.) Koehne (Indian toothcup, ROTIN), Sagittaria species, (arrowhead, SAGSS), Sesbania exaltata (Raf.) Cory/Rydb. Ex Hill (hemp sesbania, SEBEX), or Sphenoclea zeylanica Gaertn. (gooseweed, SPDZE).

In certain embodiments, the undesirable vegetation is Alopecurus myosuroides Huds. (blackgrass, ALOMY), Avena fatua L. (wild oat, AVEFA), Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) Link (junglerice, ECHCO), Lolium multiflorum Lam. (Italian ryegrass, LOLMU), Panicum dichotomiflorum Michx. (fall panicum, PANDI), Panicum miliaceum L. (wild-proso millet, PANMI), Setaria faberi Henin. (giant foxtail, SETFA), Setaria viridis (L.) Beauv. (green foxtail, SETVI), Sorghum halepense (L.) Pers. (Johnsongrass, SORHA), Sorghum bicolor (L.) Moench ssp. Arundinaceum (shattercane, SORVU), Cyperus esculentus L. (yellow nutsedge, CYPES), Cyperus rotundus L. (purple nutsedge, CYPRO), Abutilon theophrasti Medik. (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida L. (giant ragweed, AMBTR), Asclepias syriaca L. (common milkweed, ASCSY), Chenopodium album L. (common lambsquarters, CHEAL), Cirsium arvense (L.) Scop. (Canada thistle, CIRAR), Commelina benghalensis L. (tropical spiderwort, COMBE), Datura stramonium L. (jimsonweed, DATST), Daucus carota L. (wild carrot, DAUCA), Euphorbia heterophylla L. (wild poinsettia, EPHHL), Conyza bonariensis L. (hairy fleabane, ERIBO), Conyza canadensis L. (Canadian fleabane, ERICA), Helianthus annuus L. (common sunflower, HELAN), Jacquemontia tamnifolia (L.) Griseb. (smallflower morningglory, IAQTA), Ipomoea hederacea (L.) Jacq. (ivyleaf morningglory, IPOHE), Ipomoea lacunosa L. (white morningglory, IPOLA), Lactuca serriola L./Torn. (prickly lettuce, LACSE), Portulaca oleracea L. (common purslane, POROL), Sida spinosa L. (prickly sida, SIDSP), Sinapis arvensis L. (wild mustard, SINAR), Solanum ptychanthum Dunal (eastern black nightshade, SOLPT), Taraxacum officinale F. H. Wigg (common dandelion, TAROF) or Xanthium strumarium L. (common cocklebur, XANST).

In some embodiments, the compositions and methods are used to control AMBEL, AMBTR, ARTAB, BRSNN, CHEAL, DESSO, ERIBO, ERICA, GAETE, GALAP, GERSS, GLXMA, LAMAM, LAMSS, PAPRH, POLCO, POLPE, STEME, TRFPR and VERPE. In other embodiments, the compositions and methods are used to control AMBEL, AMBTR, ARTAB, BRSNN, GAETE, POLCO, POLPE, STEME and TRFPR.

In some embodiments, the compositions and methods provided herein are utilized to control undesirable vegetation consisting of grass, broadleaf and sedge weeds. In certain embodiments, the compositions and methods provided herein are utilized to control undesirable vegetation including species in the genera Amaranthus, Ambrosia, Artemisia, Brassica, Cassia, Chenopodium, Cirsium, Erodium, Galeopsis, Galium, Lamium, Malva, Matricaria, Melochia, Papaver, Polygonum, Sinapis, Stachys, Stellaria, Veronica, and Viola.

In some embodiments, the combination of (a) the compound of formula (I) or an agriculturally acceptable ester, amide, or salt thereof, (b) fluroxypyr or an agriculturally acceptable ester, amide, or salt thereof, and (c) MCPA or 2,4-D or agriculturally acceptable esters, amides, or salts thereof are used to control Conyza canadensis (Canada fleabane, ERICA). Stellaria media (chickweed, STEME), Galium aparine (cleavers, GALAP), Galeopsis tetrahit (hemp-nettle, GAETE), Chenopodium album (common lambsquarters, CHEAL), Kochia scoparia (kochia, KCHSC), Ambrosia artemisiifolia L. (common ragweed, AMBEL), Amaranthus retroflexus (redroot pigweed, AMARE), Malva pusilla (roundleaf mallow, MALPU), Erodium cicutarium (stork's-bill, EROCI), Polygonum convolvulus (wild buckwheat, POLCO), Polygonum persicaria L. (ladysthumb, POLPE), absinth wormwood (Artemisia absinthium, ARTAB), volunteer canola (Brassica napus, BRSNN), Trifolium pretense (red clover, TRFPR), Ambrosia trifida L. (giant ragweed, AMBTR), or volunteer alfalfa (Medicago sativa, MEDSA).

The compositions and methods described herein can be used to control undesirable vegetation in glyphosate-tolerant-, glufosinate-tolerant-, dicamba-tolerant-, phenoxy auxin-tolerant-, pyridyloxy auxin-tolerant-, aryloxyphenoxypropionate-tolerant-, acetyl CoA carboxylase (ACCase) inhibitor-tolerant-, imidazolinone-tolerant-, acetolactate synthase (ALS) inhibitor-tolerant-, 4-hydroxyphenyl-pyruvate dioxygenase (HPPD) inhibitor-tolerant-, protoporphyrinogen oxidase (PPO) inhibitor-tolerant-, triazine-tolerant- and bromoxynil-tolerant crops, for example, in conjunction with glyphosate, glufosinate, dicamba, phenoxy auxins, pyridyloxy auxins, aryloxyphenoxypropionates, ACCase inhibitors, imidazolinones, ALS inhibitors, HPPD inhibitors, PPO inhibitors, triazines, and bromoxynil. The compositions and methods may be used in controlling undesirable vegetation in crops possessing multiple or stacked traits conferring tolerance to multiple chemistries and/or inhibitors of multiple modes of action. In some embodiments, the compound of formula (I) or derivative thereof and fluroxypyr or derivative thereof and a complementary herbicide or salt or ester thereof are used in combination with herbicides that are selective for the crop being treated and which complement the spectrum of weeds controlled by these compounds at the application rate employed. In some embodiments, the compositions described herein and other complementary herbicides are applied at the same time, either as a combination formulation or as a tank mix.

The compositions and methods employing the combination of the compound of formula (I), fluroxypyr, and MCPA or 2,4-D or agriculturally acceptable salts, esters, or amides of any of these components, and the compositions described herein may also be employed to control herbicide resistant or tolerant weeds. Exemplary resistant or tolerant weeds include, but are not limited to, biotypes resistant or tolerant to acetolactate synthase (ALS) inhibitors, photosystem II inhibitors, acetyl CoA carboxylase (ACCase) inhibitors, synthetic auxins, photosystem I inhibitors, 5-enolpyruvylshikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes-of-action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to single or multiple herbicides, biotypes with resistance or tolerance to single or multiple chemical classes, biotypes with resistance or tolerance to single or multiple herbicide modes-of-action, and biotypes with single or multiple resistance or tolerance mechanisms (e.g., target site resistance or metabolic resistance).

The methods and compositions described herein can, further, be used in conjunction with glyphosate, glufosinate, dicamba, imidazolinones, sulfonylureas, triazolopyrimidines or 2,4-D on glyphosate-tolerant, glufosinate-tolerant, dicamba-tolerant, imidazolinone-tolerant, sulfonylurea-tolerant, triazolopyrimidine-tolerant or 2,4-D-tolerant crops. In one embodiment, the synergistic composition is used in combination with herbicides that are selective for the crop being treated and which complement the spectrum of weeds controlled by these compounds at the application rate employed. In another embodiment, the synergistic composition described herein and other complementary herbicides are applied at the same time, either as a combination formulation or as a tank mix, or sequentially. Similarly the herbicidal compounds of the present disclosure can be used in conjunction with acetolactate synthase inhibitors on acetolactate synthase inhibitor tolerant crops.

The described embodiments and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### EXAMPLES

### Example 1

### Evaluation of Herbicidal Activity of Mixtures Under Field Conditions

### Methodology

Nine small plot field trials were established across various ecozones in Alberta, Saskatchewan, Manitoba and Ontario, Canada, between 2011 and 2014 to evaluate potential synergy between 1) halauxifen-methyl (100 grams acid equivalent per kilogram (g ae/kg)), fluroxypyr-meptyl as Starane II EC (333 grams acid equivalent per liter (g ae/L) fluroxypyr), and MCPA 2-ethylhexyl ester (MCPA ester; 600 g ae/L), 2) the halauxifen-methyl+fluroxypyr premix (16.25 g ae/L halauxifen-methyl and 250 g ae/L fluroxypyr-meptyl) and MCPA ester (600 g ae/L), and 3) halauxifen-methyl (100 g ae/kg), fluroxypyr-meptyl as Starane II EC (333 g ae/L fluroxypyr), and 2,4-D 2-ethylhexyl ester (2,4-D ester; 660 g ae/L). In trials evaluating synergy between halauxifen-methyl, fluroxypyr-meptyl, and MCPA ester, actives were applied individually at rates of 6.5, 100, and 420 grams acid equivalent per hectare (g ae/ha), respectively, and in a three-way combination at identical rates. When applied individually, halauxifen-methyl was applied in all trials with Turbocharge adjuvant (50% mineral oil/39.5% surfactant blend) at 0.5% volume per volume (v/v). In trials evaluating synergy between the halauxifen-methyl+fluroxypyr premix, and MCPA ester, premix and MCPA ester were applied individually at rates of 82 g ae/ha (5 g ae/ha halauxifen-methyl+77 g ae/ha fluroxypyr) or 106.5 g ae/ha (6.5 g ae/ha halauxifen-methyl+100 g ae/ha fluroxypyr), and 350 or 420 g ae/ha MCPA ester, respectively, and in a two-way combination at rates of 82 g ae/ha premix+350 g ae/ha MCPA ester or 106.5 g ae/L premix+420 g ae/ha MCPA ester. When applied individually, the halauxifen-methyl+fluroxypyr premix was applied at a rate of 106.5 g ae/ha without an adjuvant, or at a rate of 82 g ae/ha with Turbocharge adjuvant at 0.5% v/v. In trials evaluating synergy between halauxifen-methyl, fluroxypyr-meptyl, and 2,4-D ester, actives were applied individually at rates of 5, 77, and 350 grams acid equivalent per hectare (g ae/ha), respectively, and in a three-way combination at identical rates. When applied individually, halauxifen-methyl was applied with Intake adjuvant (586 grams per liter (g/L) paraffinic oil/242 g/L alkoxylated alcohol non-ionic surfactants) at 1% volume per volume (v/v).

Trials were established as randomized complete blocks (RCBD) with four replicates. Individual treatments were 2-3 meters (m) wide and 10-11 m long. An untreated control was included in each trial. All trial sites had naturally occurring populations of weeds, which in some trials were augmented with additional weed seeds during trial establishment.

Herbicides were applied with backpack, bicycle, or tractor-mounted sprayers using carbon dioxide (CO₂) as a propellant. All sprayers delivered a uniform spray pattern that provided thorough coverage of the foliage using a water volume of 100-200 liters per hectare (L/ha). All herbicides were applied post-emergence in the spring to early-summer. At the time of herbicide applications, spring wheat, durum wheat, and winter wheat crops were at the four-leaf to three-node stage. Broadleaf weeds were at the seedling stage at the time of herbicide applications.

Evaluation

Foliar damage to target pest plants was visually assessed as percent control, compared to an untreated control plot. The assessments were based on a percent visual reduction in pest plant biomass and/or stand reduction of weed population. In general, three-to-four replicates were assessed for each treatment, and the results for each experiment (trial) are presented as overall average control. The efficacy of all treatments was assessed at 13-22 days after application (DAA) for an early season rating, 23-39 DAA for a mid-season rating, and 41-84 DAA for a late-season rating. The data were statistically analyzed using various statistical methods, generally including a Tukey's HSD Factorial Analysis of Variance with a significance level of 5%.

Colby's equation was used to determine the herbicidal effects expected from the mixtures (Colby, S. R. Calculation of the synergistic and antagonistic response of herbicide combinations. Weeds 1967 15, 20-22).

The following equation was used to calculate the expected activity of mixtures containing two active ingredients, A and B:

Expected=A+B−(A×B/100)
A=observed efficacy of active ingredient A at the same concentration as used in the mixture;
B=observed efficacy of active ingredient B at the same concentration as used in the mixture.

For mixtures containing three herbicidal active ingredients, the following equation can be used to calculate the expected activity:

$$Expected = 100 - \frac{( 100 - A ) ( 100 - B ) ( 100 - C )}{\text{10,000}}$$

A=observed efficacy of a first active ingredient at the same concentration as used in the mixture.
B=observed efficacy of a second active ingredient B at the same concentration as used in the mixture.
C=observed efficacy of a third active ingredient C at the same concentration as used in the mixture.

The results are summarized in Tables 1-4.

### Tables 1A and 1B. Synergistic Weed Control from Spring Applications of Halauxifen-Methyl+Fluroxypyr-Meptyl+MCPA Ester in Field Trials

TABLE 1A
BRSNN and GAETE

| Hal- | Flur- | | BRSNN | | | | GAETE | |
|---|---|---|---|---|---|---|---|---|
| auxifen- | oxypyr- | | 14 DAA | | 33 DAA | | 14 DAA | |
| methyl | meptyl | MCPA ester | SK | | | | AB | |
| g ae/ha | g ae/ha | g ae/ha | Obs | Exp | Obs | Exp | Obs | Exp |
| 6.5 | 0 | 0 | 20 | — | 15 | — | 79 | — |
| 0 | 100 | 0 | 30 | — | 20 | — | 39 | — |
| 0 | 0 | 420 | 80 | — | 95 | — | 31 | — |
| 6.5 | 100 | 420 | 90 | 89 | 98 | 97 | 95 | 91 |

TABLE 1B
POLPE and STEME.

| | | | POLPE | | | | | | | | | | STEME | |
|---|---|---|---|---|---|---|---|---|---|---|---|---|---|---|
| Halauxifen- | Fluroxypyr- | | 14 DAA | | 49 DAA | | | | 57 DAA | | 59 DAA | | 59 DAA | |
| methyl | meptyl | MCPA ester | AB | | AB | | SK | | AB | | AB | | AB | |
| g ae/ha | g ae/ha | g ae/ha | Obs | Exp | Obs | Exp | Obs | Exp | Obs | Exp | Obs | Exp | Obs | Exp |
| 6.5 | 0 | 0 | 0 | — | 0 | — | 10 | — | 0 | — | 33 | — | 24 | — |
| 0 | 100 | 0 | 0 | — | 0 | — | 25 | — | 23 | — | 61 | — | 15 | — |
| 0 | 0 | 420 | 0 | — | 0 | — | 30 | — | 0 | — | 35 | — | 0 | — |
| 6.5 | 100 | 420 | 50 | 0 | 55 | 0 | 60 | 53 | 73 | 23 | 89 | 83 | 88 | 35 |

BRSNN: canola, volunteer (Brassica napus)
GAETE: hemp-nettle (Galeopsis tetrahit)
POLPE: lady's-thumb (Polygonum persicaria)
STEME: chickweed, common (Stellaria media)
g ae/ha: grams acid equivalent per hectare
Obs: Observed percent weed control
Exp: Expected percent weed control as predicted by Colby equation
AB: Alberta, Canada
SK: Saskatchewan, Canada
DAA: days after application

TABLE 2
Synergistic weed control from Spring applications
of the Halauxifen-methyl + Fluroxypyr-meptyl
premix at 82 g ae/ha + MCPA ester in field trials.

| Halauxifen- | | | | | | | |
|---|---|---|---|---|---|---|---|
| methyl + | | AMBEL | | POLPE | | | |
| Fluroxypyr- | | 28 DAA | | 14 DAA | | 34 DAA | |
| meptyl | MCPA ester | ON | | MB | | MB | |
| g ae/ha | g ae/ha | Obs | Exp | Obs | Exp | Obs | Exp |
| 5 + 77 | 0 | 35 | — | 45 | — | 45 | — |
| 0 | 350 | 15 | — | 38 | — | 40 | — |
| 5 + 77 | 350 | 64 | 45 | 80 | 66 | 83 | 68 |

AMBEL: ragweed, common (Ambrosia artemisiifolia)
POLPE: lady's-thumb (Polygonum persicaria)
g ae/ha: grams acid equivalent per hectare
DAA: days after appplicaiton
Obs: Observed percent weed control
Exp: Expected percent weed control as predicted by Colby equation
MB: Manitoba, Canada
ON: Ontario, Canada

### Tables 3A and 3B: Synergistic Weed Control from Spring Applications of the Halauxifen-Methyl+Fluroxypyr-Meptyl Premix at 106.5 g Ae/Ha+MCPA Ester in Field Trials

| Halauxifen- | | | | | | | | | | | | | |
|---|---|---|---|---|---|---|---|---|---|---|---|---|---|
| methyl + | | ARTAB | | BRSNN | | GAETE | | POLCO | | | | | |
| Fluroxypyr- | MCPA | 47 DAA | | 33 DAA | | 14 DAA | | 35 DAA | | 47 DAA | | 63 DAA | |
| meptyl | ester | MB | | SK | | AB | | MB | | MB | | AB | |
| g ae/ha | g ae/ha | Obs | Exp | Obs | Exp | Obs | Exp | Obs | Exp | Obs | Exp | Obs | Exp |
| 6.5 + 100 | 0 | 0 | — | 35 | — | 70 | — | 90 | — | 92 | — | 69 | — |
| 0 | 420 | 0 | — | 95 | — | 31 | — | 0 | — | 0 | — | 43 | — |
| 6.5 + 100 | 420 | 33 | 0 | 98 | 97 | 95 | 79 | 98 | 90 | 97 | 92 | 92 | 82 |

TABLE 3B
POLPE and STEME

| Halauxifen- | | | | | | | | | | | | | | | | | |
|---|---|---|---|---|---|---|---|---|---|---|---|---|---|---|---|---|---|
| methyl + | | POLPE | | | | | | | | | | | | | | STEME | |
| Fluroxypyr- | MCPA | 14 DAA | | 34 DAA | | 49 DAA | | | | 54 DAA | | 57 DAA | | 59 DAA | | 59 DAA | |
| meptyl | ester | MB | | MB | | MB | | AB | | MB | | AB | | AB | | AB | |
| g ae/ha | g ae/ha | Obs | Exp | Obs | Exp | Obs | Exp | Obs | Exp | Obs | Exp | Obs | Exp | Obs | Exp | Obs | Exp |
| 6.5 + 100 | 0 | 42 | — | 50 | — | 45 | — | 8 | — | 71 | — | 45 | — | 59 | — | 30 | — |
| 0 | 420 | 38 | — | 40 | — | 27 | — | 0 | — | 38 | — | 0 | — | 35 | — | 0 | — |
| 6.5 + 100 | 420 | 85 | 63 | 84 | 70 | 84 | 60 | 55 | 8 | 90 | 83 | 73 | 45 | 89 | 73 | 88 | 30 |

ARTAB: absinth wormwood (Artemisia absinthium)
BRSNN: canola, volunteer (Brassica napus)
GAETE: hemp-nettle (Galeopsis tetrahit)
POLPE: lady's-thumb (Polygonum persicaria)
POLCO: wild buckwheat (Polygonum convolvulus)
STEME: chickweed, common (Stellaria media)
g ae/ha: grams acid equivalent per hectare
Obs: Observed percent weed control
Exp: Expected percent weed control as predicted by Colby equation
AB: Alberta, Canada
SK: Saskatchewan, Canada
MB: Manitoba, Canada
DAA: days after aplication

TABLE 4
Synergistic weed control from Spring applications of the
Halauxifen-methyl + Fluroxypyr-meptyl + 2,4-D ester in field trials.

| | | | AMBTR | | TRFPR | |
|---|---|---|---|---|---|---|
| Halauxifen- | Fluroxypyr- | | 49 DAA | | 84 DAA | |
| methyl | meptyl | 2,4-D ester | ON | | ON | |
| g ae/ha | g ae/ha | g ae/ha | Obs | Exp | Obs | Exp |
| 5 | 0 | 0 | 20 | — | 15 | — |
| 0 | 77 | 0 | 21.7 | — | 12.4 | — |
| 0 | 0 | 350 | 83 | — | 7.4 | — |
| 5 | 77 | 350 | 93.8 | 89.4 | 82.4 | 31.1 |

AMBTR: giant ragweed (Ambrosia trifida)
TRFPR: red clover (Trifolium pratense)
DAA: days after application
g ae/ha: grams of acid equivalent per hectare
Obs: Observed percent weed control
Exp: Expected percent weed control as predicted by Colby equation
ON: Ontario, Canada

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

What is claimed is:

1. A composition comprising a mixture comprising a herbicidally effective amount of (a) a compound of the formula (I): 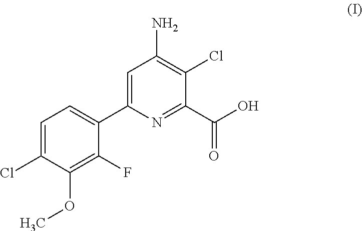 [SMILES: COc1c(Cl)ccc(-c2cc(N)c(Cl)c(C(=O)O)n2)c1F]
or, with respect to its carboxylic acid moiety, an agriculturally acceptable salt, ester, or amide thereof,
(b) fluroxypyr or, with respect to its carboxylic acid moiety, an agriculturally acceptable ester, amide, or salt thereof, and
(c) one or more phenoxy auxins or an agriculturally acceptable ester, amide, or salt thereof.

2. The composition of claim 1, wherein the phenoxy auxin is MCPA.

3. The composition of claim 1, wherein the phenoxy auxin is 2,4-D.

4. The composition of claim 1, wherein the composition further comprises a herbicide safener.

5. The composition of claim 4, wherein the safener is cloquintocet acid or cloquintocet mexyl.

6. The composition of claim 1, wherein (a) is a C₁-C₄ alkyl or benzyl ester of the compound of formula (I).

7. The composition of claim 6, wherein (a) is the methyl ester of the compound of formula (I).

8. The composition of claim 1, wherein (b) is fluroxypyr-meptyl.

9. The composition of claim 1, wherein (c) is MCPA 2-ethylhexyl ester.

10. The composition of claim 1, wherein (c) is 2,4-D 2-ethylhexyl ester.

11. The composition of claim 1, wherein the carboxylic acid equivalent weight ratio of (a) to (b) to (c) is from about 1:10:50 to about 1:30:120.

12. The composition of claim 1, wherein the carboxylic acid equivalent weight ratio of (a) to (b) to (c) is about 1 to about 15 to about 70.

13. A method of controlling undesirable vegetation comprising contacting the undesirable vegetation, the area adjacent to the undesirable vegetation, water, or soil with a herbicidally effective amount of the composition of claim 1.

14. The method of claim 13, wherein (a) is the methyl ester of the compound of formula (I), (b) is fluroxypyr-meptyl, and (c) is MCPA 2-ethylhexyl ester.

15. The method of claim 13, wherein (a) is the methyl ester of the compound of formula (I), (b) is fluroxypyr-meptyl, and (c) is 2,4-D 2-ethylhexyl ester.

16. The method of claim 13, wherein the undesirable vegetation is Canada fleabane (Conyza canadensis, ERICA), chickweed (Stellaria media, STEME), cleavers (Galium aparine, GALAP), hemp-nettle (Galeopsis tetrahit, GAETE), common lambsquarters (Chenopodium album, CHEAL), kochia (Kochia scoparia, KCHSC), common ragweed (Ambrosia artemisiifolia, AMBEL), redroot pigweed (Amaranthus retroflexus, AMARE), roundleaf mallow (Malva pusilla, MALPU), stork's-bill (Erodium cicutarium, EROCI), wild buckwheat (Polygonum convolvulus, POLCO), ladysthumb (Polygonum persicaria L., POLPE), absinth wormwood (Artemisia absinthium, ARTAB), volunteer canola (Brassica napus, BRSNN), volunteer alfalfa (Medicago sativa, MEDSA), red clover (Trifolium pretense, TRFPR), or giant ragweed (Ambrosia trifida L., AMBTR).

17. The method of claim 13, wherein the composition is applied pre-emergently.

18. The method of claim 13, wherein the composition is applied post-emergently.

19. The method of claim 13, wherein the composition is applied at a use rate of 5 grams carboxylic acid equivalent weight per hectare (g ae/ha) of (a), 77 g ae/ha of (b), and 350 g ae/ha of (c).

20. A kit for controlling undesirable vegetation comprising:
a first composition comprising a herbicidally effective amount of (a) a compound of the formula (I): 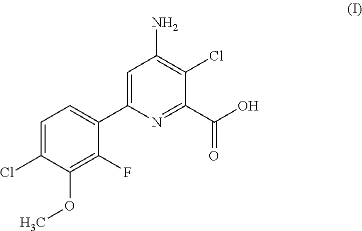 [SMILES: COc1c(Cl)ccc(-c2cc(N)c(Cl)c(C(=O)O)n2)c1F]
or, with respect to its carboxylic acid moiety, an agriculturally acceptable salt, ester, or amide thereof, and (b) fluroxypyr, or, with respect to its carboxylic acid moiety, an agriculturally acceptable ester, amide, or salt thereof, and
a second composition comprising a herbicidally effective amount of (c) one or more phenoxy auxins or an agriculturally acceptable ester, amide, or salt thereof,
wherein the first composition and the second composition are contained separately from each other in the kit.

21. The kit of claim 20, wherein the phenoxy auxin is MCPA.

22. The kit of claim 20, wherein the phenoxy auxin is 2,4-D.

23. The kit of claim 20, wherein the first and second compositions further comprise a herbicide safener.

24. The kit of claim 23, wherein the safener is cloquintocet acid or cloquintocet mexyl.

25. The kit of claim 20, wherein (a) is a C₁-C₄ alkyl or benzyl ester of the compound of formula (I).

26. The kit of claim 25, wherein (a) is the methyl ester of the compound of formula (I).

27. The kit of claim 20, wherein (b) is fluroxypyr-meptyl.

28. The kit of claim 20, wherein (c) is MCPA 2-ethylhexyl ester.

29. The kit of claim 20, wherein (c) is 2,4-D 2-ethylhexyl ester.

30. The kit of claim 20, wherein the carboxylic acid equivalent weight ratio of (a) to (b) to (c) is from about 1:10:50 to about 1:30:120.

31. The kit of claim 20, wherein the carboxylic acid equivalent weight ratio of (a) to (b) to (c) is about 1 to about 15 to about 70.

32. A method of controlling undesirable vegetation comprising contacting the undesirable vegetation, the area adjacent to the undesirable vegetation, water or soil with a herbicidally effective amount of
(a) a compound of the formula (I): 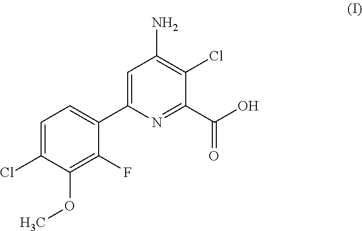 [SMILES: COc1c(Cl)ccc(-c2cc(N)c(Cl)c(C(=O)O)n2)c1F]
or, with respect to its carboxylic acid moiety, an agriculturally acceptable salt, ester, or amide thereof,
(b) fluroxypyr, or, with respect to its carboxylic acid moiety, an agriculturally acceptable ester, amide, or salt thereof, and
(c) one or more phenoxy auxins or an agriculturally acceptable ester, amide, or salt thereof.

33. The method of claim 32, wherein the phenoxy auxin is MCPA.

34. The method of claim 32, wherein the phenoxy auxin is 2,4-D.

35. The method of claim 32, wherein (a) is the methyl ester of the compound of formula (I), (b) is fluroxypyr-meptyl, and (c) is MCPA 2-ethylhexyl ester.

36. The method of claim 32, wherein (a) is the methyl ester of the compound of formula (I), (b) is fluroxypyr-meptyl, and (c) is 2,4-D 2-ethylhexyl ester.
